(19) United States
(12) Patent Application Publication
(10) Pub. No.: US 2008/0140584 A1
(43) Pub. Date: Jun. 12, 2008

(54) Estimating expected multi-period performance of discrete-period rules-based dynamic investments

(76) Inventor: Ronald Hylton, New York, NY (US)

Correspondence Address: MINTZ LEVIN COHN FERRIS GLOVSKY & POPEO;ATTN: PATENT INTAKE CUSTOMER NO. 35437, ONE FINANCIAL CENTER, BOSTON, MA, 02111, US

(21) Appl. No.: 11/824,991

(22) Filed: Jul. 2, 2007

Related U.S. Application Data
(60) Provisional application No. 60/818,041, filed on Jun. 30, 2006.

(51) Int. Cl. G06Q 40/00

(52) U.S. Cl. 705/36 R; 705/35

(57) ABSTRACT

Several methods are applied for providing an investor performance evaluation analysis of certain investments. A Continuous-Time method, Taylor Series expanding and compounding method and a Monte Carlo with Brownian Bridges simulation method produce useful statistical answers per each investment during a multitude of periods, including the expected performance, standard deviation around the expected performance, various confidence intervals, and even an estimate of the actual distribution of future returns. Additionally, important features such as the dependence of such an investment on market volatilities, correlations, dividends, and interest rates are made apparent to the investor and sometimes precisely quantified.

### REFERENCE TO RELATED APPLICATIONS

The present application is based upon and claims priority from U.S. Provisional Patent Ser. No. 60/818,041, filed on Jun. 30, 2006, the entire contents of which are herein incorporated herein by reference.

### FIELD OF THE INVENTION

Embodiments of the present invention relate to methods for evaluating characteristics of certain investments, and more particularly, to methods for providing benchmarks and other useful analyses for an evaluation of investment performance over investment periods.

### BACKGROUND OF THE INVENTION

Investment products that employ a strategy which utilizes a set of rules to dynamically alter the characteristics of the investment on a regular basis have become popular. A particular example exists of dynamic mutual funds offered by ProFunds and Rydex. This offering targets a percent return that is a fixed multiple of the percent return of some benchmark on a daily basis, for example an offering might target a percent return that is twice the percent return of the S&P 500 on a daily basis. In such a case, the standard rule is to adjust the characteristics of the investment to provide twice the percent return of the S&P 500, where the period involved happens to be a single day.

The aforementioned types of investments are generally easy for an investor to understand on a single-period basis, but over multiple periods, the expected performance of such an investment may not be transparent to the average investor. As applied to the example stated above, in the case of twice the percent return of the S&P 500 fund, the investor might also wish to know how his investment will perform if the S&P 500 is up 15% three months from now. Within the current state of the art, there exists no way for an investor to get a useful answer to such a question. Indeed, the answer may entail features that are quite surprising and unexpected to the investor, such as a strong sensitivity to the volatility of the S&P 500 over the three months.

Thus, having the capabilities to analyze the expected performance and other performance measures of such a fund over a multitude of periods and other underlying applied characteristics, would be desirable within the financial world. These types of analysis are valuable to an investor in such situations when considering whether to make or exit such an investment. Providing these types of answers, along with other pertinent analysis, is important in meeting regulatory requirements related to an investment, such as disclosure requirements.

Generally, it is not possible to exactly evaluate such an investment over multiple periods due to the investment's dependency on the exact sequence of the relevant market values over all the investment periods. However, in light of merely the initial and final benchmark values being specified, it is desired to determine useful statistical answers that can be given, such as the expected performance, standard deviation around the expected performance, various confidence intervals, and even an estimate of the actual distribution of future returns or investment values. Additionally, it is also desired to assess and precisely quantify to an investor important features such as the dependence of such an investment on market volatilities, correlations, dividends, and interest rates.

In view of the foregoing, it would be desirable to provide improved systems for evaluating investment characteristics pertaining to multiple scenarios and/or investment periods.

### SUMMARY OF THE INVENTION

Embodiments of the present invention relate to providing an investor performance evaluation analysis of an investment.

In an embodiment of the present invention, a method for evaluating investment performance of an investment is provided. The method includes setting a period of evaluation of the investment, determining initial benchmark and final benchmark values for the investment for the period, determining market characteristics within the period, applying a substantially constant leveraging factor L to the investment, and converting the benchmark value, the investment value, the investment rules, and the market characteristics to continuous functions of time in accordance with the formula d(ln V)=L*d(ln S), where V is an investment value and S denotes a benchmark value. The method further details estimating an expected performance V(T) of the investment for T years for the market characteristics in accordance with a formula: V(T)=(S_{T}/S_{O})^{L}e^{yT}, y=Lq+(1−L)r+L(1−L)σ²/2, where S_{O} is the current value of the benchmark, S_{T} is the value of the benchmark after T years, q is the average benchmark dividend yield, r is the average funding rate for the investment, and σ² is the average benchmark variance over the evaluation period; wherein the formula has been found by solving the partial differential equation resulting from the conversion of the investment to a continuous-time investment. The formula for V(T) has been found by solving the partial differential equation for V resulting from the conversion of the investment to a continuous-time investment.

In an embodiment of the present invention, a method for evaluating performance of an investment is provided. The method includes setting a multi-period of evaluation for the investment, determining one or more market characteristics, determining initial benchmark and final benchmark values for each individual period, where each individual period is a predetermined interval, determining a return of the investment over each multi-period and compounding the multi-period returns to realize a total return or investment value in accordance with the formula: ln(1+rₜₒₜₐₗ)=ln(1+r₁)+ln(1+r₂) . . . +ln(1+r_{N}), where rᵢ=L*(Sᵢ/Sᵢ₋₁−1). The method further details approximating the multi-period returns via second or higher order expansion, expressing benchmark returns for each individual period in accordance with the formula ln (Sᵢ₊₁/Sᵢ), where Sᵢ are benchmark values, summing the benchmark returns for the multi-period to produce a first-order total return in accordance with the formula ln (S_{N}/S_{O}), where S_{O} is an initial benchmark value and S_{N} is a final benchmark value for the multi-period of evaluation, and calculating expected values over the intermediate benchmark values to eliminate them from terms of order greater than 1. Furthermore, the method entails combining all of the multi-period returns and a funding return via the formula: V(T)=(S_{T}/S_{O})/^{L}e^{yT}, y=Lq+(1−L)r+L(1−L)(σ²/2+σ⁴t/4), where T is the total investment period, t is the basic compounding period in years, L represents a substantially constant leverage value, σ⁴ captures effects of discrete compounding and σ² yields statistical properties of the total return, and where the effective funding rate is (Lq+(1−L)*r), where q is the dividend rate, and r is the interest rate.

In an embodiment of the present invention, a method for estimating multi-period performance of an investment is provided. The method includes selecting a market model to be utilized for simulation, initiating two benchmark values at a starting value and a final value, filling the benchmark values during intervals present within the multi-period, wherein random increments are utilized that are consistent with the market model plus starting and final values, and generating a path of random or quasi-random values consistent with the market model plus starting and final values by utilizing a Brownian Bridge technique, where a Brownian Bridge technique utilizes a specified initial benchmark value and a final benchmark value to find an intermediate value. The method further details evaluating investment performance parameters over the path and accumulating statistical properties of the investment over multiple paths.

The foregoing and other features, aspects, and advantages of the present invention will be more apparent from the following detailed description, which illustrates exemplary embodiments of the present invention.

### BRIEF DESCRIPTION OF THE DRAWINGS

For a better understanding of the present invention, reference is made to the following description, taken in conjunction with the accompanying drawings, in which like reference characters refer to like parts throughout, and in which:

FIG. 1 relates to a general method for evaluating investment performance in accordance with some embodiments of the present invention.

FIG. 2 relates to a Continuous-Time method for evaluating investment performance in accordance with some embodiments of the present invention.

FIG. 3 relates to a Taylor Series Expansion of Compounding method for evaluating investment performance in accordance with some embodiments of the present invention.

FIG. 4 relates to a Monte Carlo Simulation with Brownian Bridges method for evaluating investment performance in accordance with some embodiments of the present invention.

FIG. 5 relates to the Brownian Bridge Monte Carlo method as illustrated in FIG. 4.

### DETAILED DESCRIPTION OF THE INVENTION

The following description focuses on several methods for providing useful evaluation analysis that an investor may use to assess the characteristics of an investment or that a company offering an investment product might use to meet regulatory requirements. According to some embodiments of the present invention, a key aspect is that the forthcoming methods of the invention, discussed below, only require the initial and final values of the benchmark, rather than the values for each period

The detailed description will focus on embodiments of the present invention via an example using investments similar to the two×S&P 500 fund as described above, characterized by a one-day period and dependence on a single benchmark and a simple rule. One of skill in the art will appreciate that it is relatively straightforward to generalize the methods disclosed herein for other periods, multiple benchmarks, and more complex rules and apply to different scenarios all within the scope applied herein.

A Black-Scholes market environment will be assumed—i.e. that asset returns are log-normally distributed with constant volatility, dividend yields, and interest rates. Other assumptions can be substituted in a straightforward manner, but this particular market model is typically commonly used, relatively tractable, and generally adequate for the purposes envisioned here, and would be recognized by one of ordinary skill in the art.

In some embodiments of the present invention, rules-based investments may allow “slippage” in which the rules may not be exactly followed at all times. Some of the embodiments disclosed herein assume the rules are always followed exactly, and any “slippage” will tend to increase the uncertainty of the investment performance though typically does not significantly affect the expected performance. This is asserted because “slippage”, by definition, is a random effect; therefore, as applied to embodiments of the present invention, the random effect asserts that the rules being followed remain the rules disclosed to the investor and applied by the fund manager.

In accordance with some of the embodiments presented, a standard example is applied to each forthcoming method of analysis. The standard example provides an investment that gives a percent return that is a fixed multiple of the percent return of one or more particular benchmarks in each period of the investment. Further within each standard example, reference will also be made to a multiplier L, which acts as the leverage of the investment. The standard example coincides with an important class of investments currently offered by ProFunds and Rydex with around $12 billion under management by these two companies. Investor information provided by ProFunds and Rydex typically imparts insight as to how these investments will perform over investment periods consisting of 1 or 2 days. By utilizing the standard example within the analysis of each forthcoming method presented herein, the performance of such investments will be evaluated over longer periods, which further depends strongly on the volatility of the benchmark, a fact that is of considerable value to an investor contemplating such an investment. It also turns out, that to good accuracy, the expected performance of the investment over any time horizon, which depends only on the final value of the benchmark and the volatility (plus interest rates and dividends), correlates with a formula for deducing the total return which allows the investor to easily evaluate the performance of the investment over different market scenarios; hereby incorporated via the use of the methods presented herein.

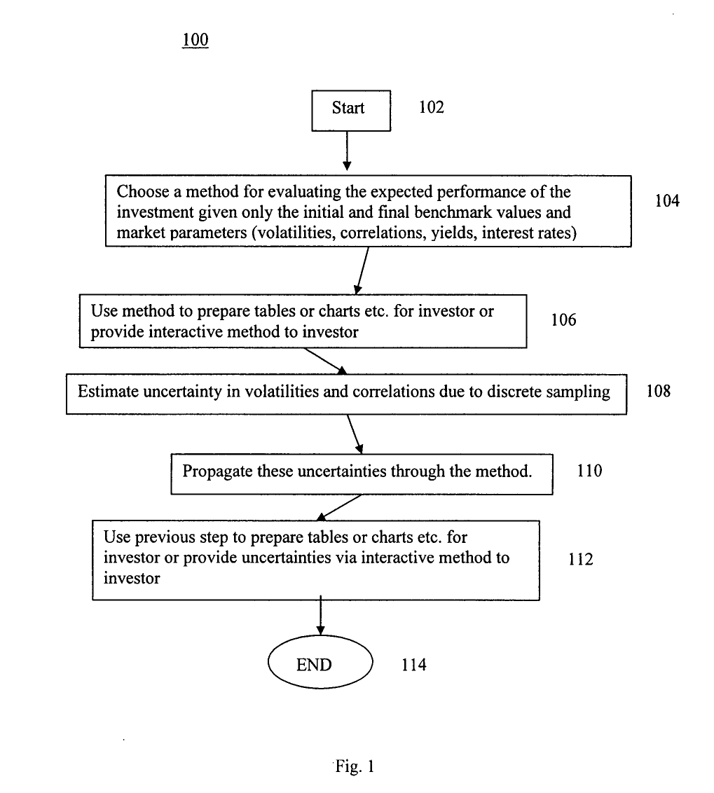

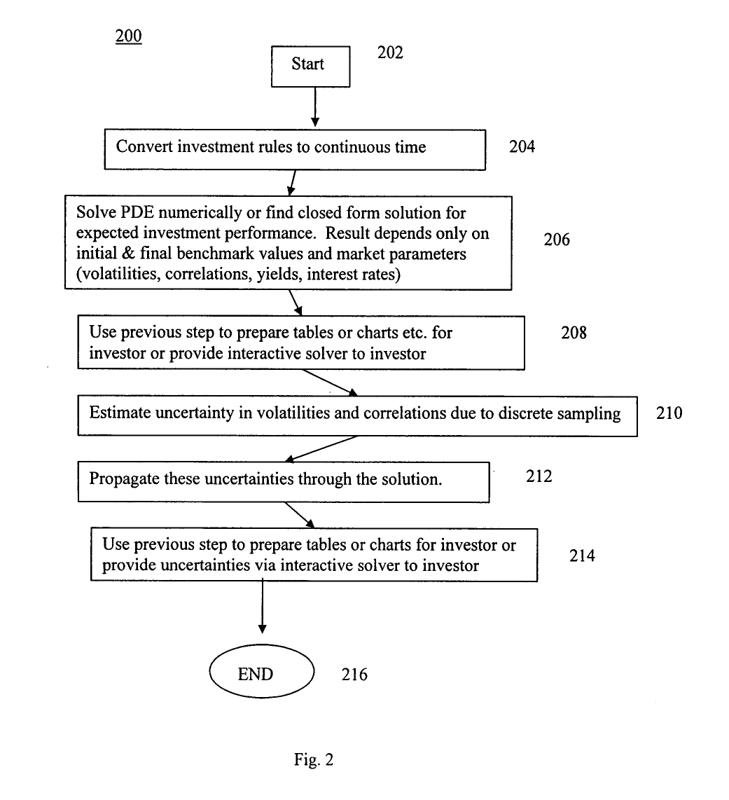

FIG. 1 relates to a general method 100, for evaluating investment performance. Overall, provided within the general method 100 are steps, which applied to each succeeding method, provide a basic overview of the evaluation process of a particular investment strategy. The general method 100 begins with step 102 and subsequently by choosing a particular method (provided below in relation to FIGS. 2-5) for evaluating the expected performance of the investment given only the initial and final benchmark values and market parameters 104. The market parameters entail volatilities, correlations, yields, dividends and interest rates. The selected method is utilized to prepare graphic representation for each investor, or to provide a delivered version to investors in interactive form via a web browser or computer application 106. The graphic representation being tables, charts, graphs, diagrams, and/or any other type of visual aid which would be recognized by one of ordinary skill in the art. Therein, an estimation of uncertainty in volatilities and correlations through the use of discrete sampling 108. Further, alternate embodiments provide an estimation of other market parameters, discussed above, in view of uncertainties via discrete sampling. After these uncertainties are estimated, they are propagated through the selected method 110. Herein, after all the values are calculated, once more prepare graphic representations for the investor or provide the estimated values correlating to uncertainties via an interactive method to the investor 112. The general method ends with step 114.

FIG. 2 relates to a Continuous-Time method 200 for evaluating investment performance. The Continuous-Time method replaces that which was old in art, Discrete-Time rules. In some cases it happens that, when the rules are assumed to apply on a Continuous-Time basis rather than a discrete-time basis, it enables the possibility to find a “closed-form” solution for future investment performance. In some embodiments, such a solution may depend only on the initial and final benchmark values, plus market characteristics such as volatilities, correlations, interest rates, dividends, etc. The Continuous-Time performance provides a good estimate for the expected performance of the actual discrete-time investment, with the tightness of the estimate increasing as the number of discrete periods under consideration increases.

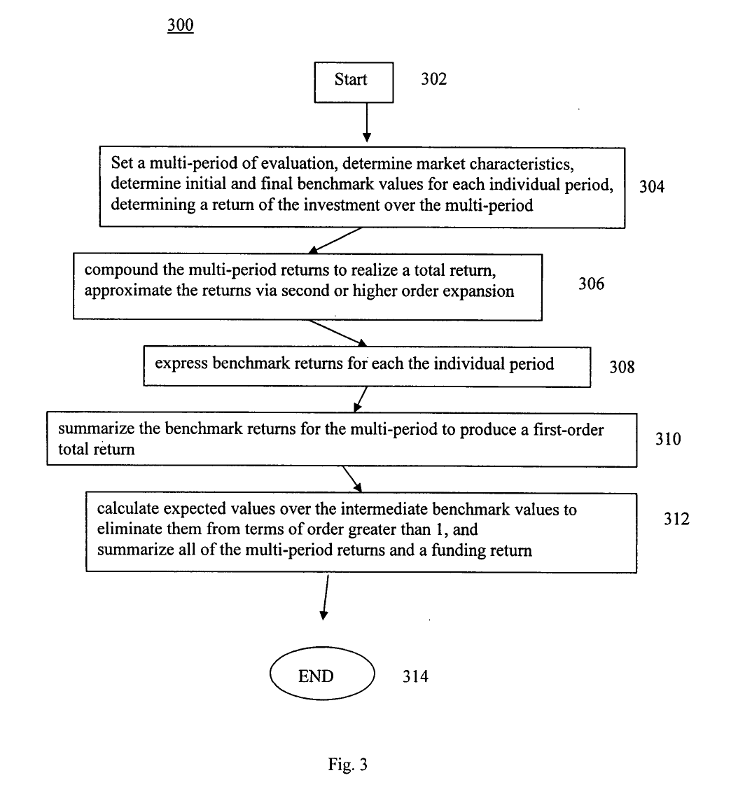

In some embodiments within the Continuous-Time method 200, it may not be possible to find a closed form solution, but instead a standard method may be used to efficiently solve the partial differential equation (PDE) that results from the Continuous-Time method 200, in which case the numerical solution of the standard method has almost the same utility as a closed-form solution. In some cases it is not possible to apply the discrete-time rules on a continuous basis (e.g. when the discrete-time return is capped at a fixed level) and one of the other methods presented below will need to be used, as discussed in relation to FIGS. 3-5.

In accordance with a preferred embodiment of the Continuous-Time method 200, the standard example is an investment product in which the percent investment return over each discrete period is a fixed multiple of the percent investment return for some benchmark. Expressed as a formula/rule and converting percents to fractions this becomes:

(Vᵢ₊₁−Vᵢ)/Vᵢ=L*(Sᵢ₊₁−Sᵢ)/Sᵢ

where V is the investment value, S is the benchmark value, the subscript refers to the value at the end of the ith period and L represents a substantially constant leverage value over a period of time. The equation can be expressed in percentages as well by multiplying each side by a factor of 100.

The Continuous-Time method 200 begins with step 202 and requires applying this rule in continuous time rather than at discrete intervals, so the formula becomes:

dV/V=L*S/S

where S and V are now continuous functions of time; the explicit dependence on time is not shown for simplicity. Through this analysis, typical investment rules are converted to Continuous-Time 204.

The continuous time formula may immediately be recognized as d(ln V)=L*d(ln S) leading to investigation of a payoff function of the form V=S^{L}. Standard textbook techniques discussed in conjunction with the Black-Scholes equation can now be used to derive a partial differential equation for the value of a version of this product with a fixed maturity date and the result immediately generalizes to all maturities. Standard techniques can be used to solve this PDE numerically or in this case find a closed-form solution. The standard example assumes that the instantaneous return of the investment is a fixed multiple of the instantaneous return of the benchmark and it's assumed that the benchmark is described by the Black-Scholes model, where one can derive and solve the corresponding partial differential equation. The result depends only on initial & final benchmark values and market parameters 206. For the standard investment there is a closed-form solution, in T years:

V(T)=(S_{T}/S_{O})^{L}e^{yT},y=Lq+(1−L)r+L(1−L)σ²/2

where S_{O} is the current value of the benchmark, S_{T} is the value of the benchmark T years in the future, q is the average benchmark dividend yield over the investment horizon, r is the average funding rate for the investment over the investment horizon, L represents a substantially constant leverage value over a period of time, and σ² is the average benchmark variance (volatility squared) over the investment horizon. The formula for V(T) assumes an initial investment of $1 and gives the expected value of the investment T years in the future.

Financial textbooks usually focus on the case where PDE's are solved backwards in time from a fixed maturity date to today. For the method discussed here it is somewhat more natural to solve forwards in time (i.e. solving the forward Kolmogorov or Fokker-Planck equation), but both techniques are acceptable as the interest is in the relative value of the investment now and at some future date given the value of the benchmarks now and at the future date.

The formula above provides a good estimate of the expected performance of the investment depending only on the initial and final benchmark values, benchmark volatility, benchmark yield, and interest rate (quite similar to an option pricing formula). The formula can be used to prepare summary information (such as tables, graphs or other visual displays) for investors or could be delivered to investors in interactive form via a web browser or computer application 208.

It is sometimes also possible to use the Continuous-Time solution to estimate the uncertainty of the discrete-time performance. In particular, when the Continuous-Time performance depends on volatilities and correlations, the discrete-time performance will (according to one embodiment) depend on those same quantities measured by sampling on discrete intervals 210. In alternate embodiments, for a discretely compounded investment, the formula is an expected value, the average of a range of values. The width of this range is primarily determined by the uncertainty in variance, since it is variance measured over the discrete samples that the actual investment depends. The statistical characteristics of such discretely-sampled volatilities and correlations can be propagated through the Continuous-Time solution to estimate the statistical characteristics of the discrete-time performance 212.

Due to the discrete sampling characteristics of the actual investment the effective volatility “seen” by the investment will not be the exact benchmark volatility used as input to the formula but rather will randomly differ from this depending on the exact set of benchmark values that occurs in the future. This introduces an uncertainty in investment performance which can be addressed by estimating the uncertainty in volatility (or variance) due to the discrete sampling and propagating this volatility or variance uncertainty through the formula 212.

For the Black-Scholes market model, the uncertainty in variance is well described by a chi-squared distribution with degrees of freedom given by the number of discrete periods, or for some methods of calculation the number of discrete periods less one. This is convenient because the statistical properties of chi-squared are recognized by those of ordinary skill in the art. The propagation of the statistical uncertainty in volatility or variance can be done in various ways, e.g. by differentiating the formula with respect to volatility or variance to propagate the standard deviation of variance 212, by choosing specific confidence levels of chi-squared and propagating the corresponding variance value through the formula to find the confidence intervals in investment performance, or by sampling the chi-squared distribution and propagating the samples through the formula to get a distribution of investment performance. For other market models a numerical procedure, for example a Monte Carlo simulation, may be required to estimate the uncertainty in market parameters due to discrete sampling for propagation through the solution.

The Continuous-Time method 200 subsequently follows the step of utilizing the propagated values to prepare summary information (such as tables, graphs or other visual displays) for investors or could be delivered to investors in interactive form via a web browser or computer application 214. The method 200 ends with step 216, where a continuous time performance acts as an estimate of the expected value of the actual discrete-time investment.

The dependence of this investment on volatility is quite important to the investor; it is a component of the “carry” of the investment that needs to be considered when evaluating the investment. When applied retroactively to certain investments made during the “tech bubble” (e.g. standard-type investments offered by ProFunds and Rydex with leverages of −2 on the NASDAQ 100 index) it reveals high carry costs that investors were unaware of and that resulted in poor performance of the investments. Given this formula, the investor can then determine what the future level of S is that causes his investment to break even, a very useful criterion for evaluating the investment. Of course, in practice management fees, transaction costs, and other forms of “friction” may also need to be considered.

The statistical properties of variance can, with reasonable accuracy, be considered as those of the chi-squared distribution with degrees of freedom equal to one less than the number of discrete periods in the investment horizon; or in some cases equal to the number of discrete periods in the investment horizon. From this, one can estimate the statistical properties of V. In one embodiment, it is common practice to use the first derivative of a non-linear expression such as the one above with respect to a parameter subject to statistical variation to propagate statistical properties of the parameter (such as standard deviation) to the result of the formula. In some embodiments, some higher derivatives may be necessary or may provide higher accuracy in the propagation of statistical properties of parameters (such as volatility or variance) to the actual investment performance. In some unusual cases it might be necessary to use a Monte Carlo simulation or some other numerical technique to propagate statistical properties through the formula.

FIG. 3 relates to a Taylor Series Expansion of Compounding method 300 for evaluating investment performance. Often, a major problem in estimating the multi-period performance of these investments is due to the discrete compounding of the returns. Single-period returns are easy to understand, but since multi-period returns are built up by compounding the relevant single-period returns the complexity grows quickly. However, when the single-period returns are small, a Taylor series expansion method 300 can be used to approximate the compounding which, in conjunction with some other appropriate approximation, leads to results that only depend on initial and final benchmark values plus the market properties noted above. Alternatively it may be possible to use another expansion of similar utility, for example an expansion in Chebyshev polynomials. The expansion and compounding method 300 begins with step 302 and thereby follows by accumulating market characteristics (as discussed above), initial and final benchmark values for each individual period of the set multi-period time span, approximating the initial and final benchmark values for each individual period, and determining a return or value of the investment over the multi-period 304.

Generally, it is easiest to work with the (natural) log of 1+the return, since the log of 1+the multi-period return is the sum over all the single periods of the log of 1+the single-period return. In this case, the key is the Taylor series expansion of ln(x) around x=1. The desired accuracy may be to the second order for the returns, which captures the effect of variance and covariance; whereas multi-period returns are compounded to realize a total return, which are approximated via a second order or higher order expansion 306. To eliminate the first-order dependence on intermediate benchmark values, it is also often useful to introduce an approximation or transformation that introduces ln(Sᵢ₊₁/Sᵢ) where the Sᵢ are the benchmark values 308. Then, when the periods are summed, only ln(S_{N}/S_{O}) will remain, where S_{O} and S_{N} are the initial and final benchmark values as desired 310. Expectation values are then taken or calculated over the intermediate benchmark values (with independent increments or in some cases conditioned on the initial and/or final benchmark value) so that the higher-order terms, of an order greater than 1, become functions of the market characteristics and other statistical properties of the benchmark values rather than the exact values of the intermediate benchmark values, and subsequently, all of the multi-period returns and a funding return are summarized 312. It is also useful in some cases to make use of the log-normal assumption, as this can simplify the way volatility and correlation appear in the results. In this case, it may also be useful to recognize that when single-period returns are small then variance is also small over a single period and terms like exp(−σ²t/2) can be accurately expanded to first order in t 310. As discussed for the Continuous-Time method, the market characteristics “seen” by the actual investment are not the ones that appear in the formula but rather the ones measured by discrete sampling over the multi-period. This results in uncertainties that can be propagated through the formula found with the Taylor Series Expansion of Compounding exactly as described for the Continuous-Time method. The discretely-sampled market characteristics include volatilities and correlations.

The Taylor Series Expansion and Compounding method 300 is based on the compounding of the multi-period returns to get the total return 306, written as a formula:

1+rₜₒₜₐₗ=(1+r₁)*(1+r₂) . . . *(1+r_{N}).

As discussed above this is more conveniently written in terms of logs:

ln(1+rₜₒₜₐₗ)=ln(1+r₁)ln(1+r₂) . . . +ln(1+r_{N}).

When the single period returns are small, the logs can be accurately expanded as a Taylor series around 1, usually to second order to capture the effects of volatility and correlation 306. A higher order expansion can be used to increase the accuracy if necessary.

For the standard case rᵢ=L*(Sᵢ/Sᵢ₋₁). For simplicity, the contribution of interest rates and dividends to the return have been omitted but these can easily be accounted for (i.e the total funding for a short period of t years is (Lq+(1−L)r)*t, where q is the dividend rate and r is the interest rate and the effective funding rate is (Lq+(1−L)*r)).

The Taylor expansion gives ln(1+rᵢ)=L*(Sᵢ/Sᵢ₋₁)− 1/2(L*(Sᵢ/Sᵢ₋₁1))² to second order around rᵢ=0.

Using the same expansion with L=1 gives ln(Sᵢ/Sᵢ₋₁)=(Sᵢ/Sᵢ₋₁)−½(Sᵢ/Sᵢ₋₁−1)², this last result can be used to eliminate the (Sᵢ/Sᵢ₋₁1) in the previous result giving:

ln(1+rᵢ)=L*ln(Sᵢ/Sᵢ₋₁)+½(L−L²)*(Sᵢ/Sᵢ₋₁−1)².

When summed over all periods the ln(Sᵢ/Sᵢ₋₁) combine to give ln(S_{N}/S_{O}) as desired and the intermediate Sᵢ values only appear in the squared terms. Since we only need expectation values for intermediate times we can now average over the intermediate Sᵢ (assuming independent increments) and by using the log-normal assumption for the Sᵢ find that the expected value of (Sᵢ/Sᵢ₋₁−1)² is σ²t+σ⁴t²/2 to second-order accuracy in t where t is the compounding period in years 308, 310, 312. Summing this over all periods and including the funding return gives

V(T)=(S_{T}/S_{O})^{L}e^{yT},y=Lq+(1+L)r+L(1−L)(σ²/2+σ⁴t/4)

where T is the total investment period. This differs slightly from the previous formula and is slightly more accurate because the σ⁴ term partially captures the effect of discrete compounding. In practice, for low volatility underliers, it is usually negligible. As in the first case, the statistical properties of σ² can be propagated through the formula to yield the statistical properties of the total return. The formula can now be used as described for the Continuous-Time method as described above 312.

In what follows, the effect of interest rates and dividends are ignored as these are easy to account for. The single-period return +1 is given by 1+L*(bᵢ−1) where bᵢ is short for Sᵢ₊₁/Sᵢ and bᵢ₋₁ is the return of the benchmark over the i-th period. Thus, we need to expand ln(1+L*(bᵢ−1)) around bᵢ=1. Since the period is a single day the return of the benchmark is likely to be small and a second-order expansion quite accurate. Using the log-normal assumption, bᵢ=e^{σ\sqrt{t}z}^{ᵢ}^{+(r-q-σ}^{²}^{/2)t}, where zᵢ is a standard normal variate. After expanding the log, summing over the single periods to get the log of the total return, taking expectation values over the intermediate benchmark values, we find that the expected investment performance, as discussed above, is:

V(T)=(S_{T}/S_{O})^{L}e^{yT},y=Lq+(1−L)r+L(1−L)(σ²/2+σ⁴t/4)

where t is the basic compounding period in years 312. The formula can be used to prepare summary information (such as tables, graphs or other visual displays) for investors or could be delivered to investors in interactive form via a web browser or computer application. Furthermore, the formula can be used as described for the Continuous-Time method 200, as discussed above, and the expanding and compounding method ends via step 314.

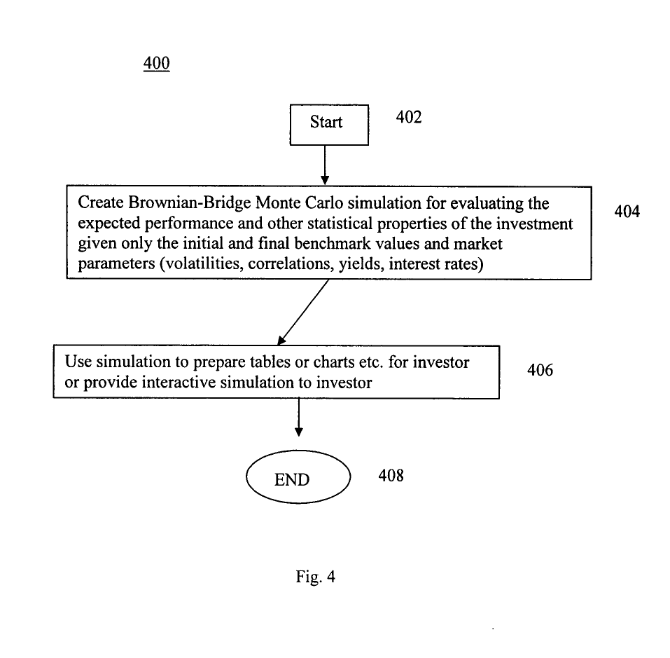

FIG. 4 relates to a Monte Carlo Simulation 400 with Brownian Bridges method for evaluating investment performance and estimating multi-period performance. The Brownian Bridge Monte Carlo simulation begins with step 402 and results in evaluating expected performance and other statistical properties of the investment, where only the initial and final benchmark values and market parameters are given 404. The market parameters include volatilities, correlations, yields and interest rates. The simulation 400 is utilized to ultimately prepare visual aids and/or graphic representations for an investor and to provide interactive simulation for the investor, via a web browser or computer application which would be recognized by one of ordinary skill in the art, 406. The overall process concludes with step 408.

Alternate embodiments of the Monte Carlo Simulation 400 may also be implemented. The Monte Carlo Simulation 400 may also be put into practice along with other statistical techniques. These other statistical techniques would be recognized by one of ordinary skill in the art. These alternate techniques would embody methods that can be used to fill in the intermediate values, as described below.

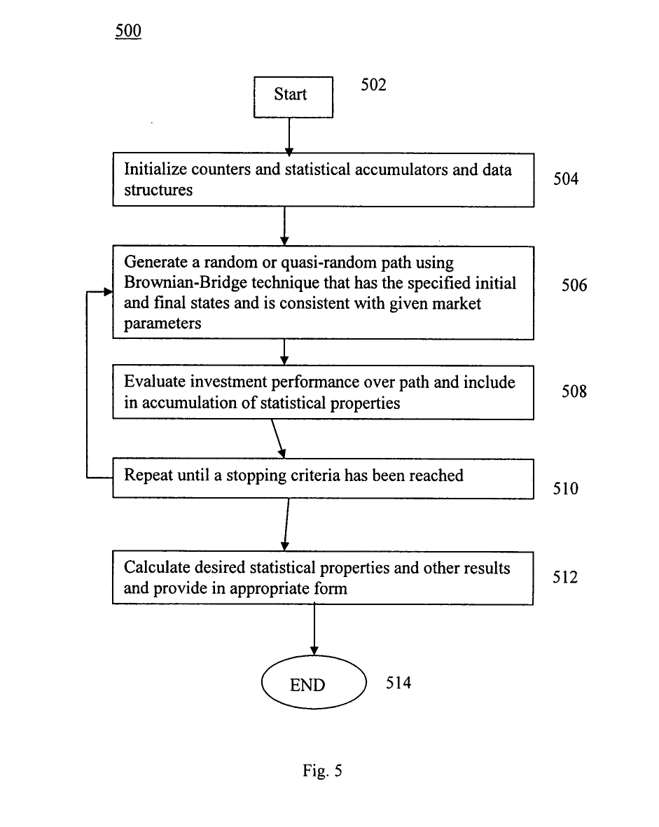

FIG. 5 relates to the Brownian Bridge Monte Carlo 500 method as illustrated in FIG. 4. The Monte Carlo Simulation with Brownian Bridges method 500 allows specification of both the starting values and ending values of all the simulated benchmarks over the total investment period, randomly or quasi-randomly filling in all the intermediate (e.g. daily) values according to the market model employed. By generating many such paths and carrying out the investment rules over each path, the expected performance at a future date can be determined, as well as many statistical properties of the performance, such as standard deviation, confidence levels, and even a full distribution of outcomes. Note that Monte Carlo Simulation with Brownian Bridges as discussed herein will typically use the same ending values for each path. Transaction costs are easily incorporated in this method if desired. This method can also be used to study alternate investment strategies with shorter or longer investment periods and choose a period that was optimal under some criterion.

This is generally the most flexible method, but also the least efficient and the hardest to deliver to the investor. It is possible to use this method 500 to prepare tables or other summary information for use by the investor, for example tables or graphs showing the expected performance as a function of benchmark level and volatility for a given time horizon. By focusing on scenarios where the benchmark ends exactly where it began, this method can be used to estimate the carry or cost of the investment, and how the carry depends on volatilities, interest rates, etc. This information can then be summarized and presented to the investor.

Normally, a Monte Carlo simulation with Brownian Bridges will produce values close to the ones given by the formulas above (assuming a sufficient number of trials are used). By focusing on the case where the benchmark ends unchanged, it is possible to deduce the formula for y, the cost of carry, given above. In fact one could probably deduce the whole formula using suitable regressions.

A Monte Carlo simulation 500 of an investment usually proceeds, step 502, by starting the benchmark values, counters, and other statistical accumulators and data structures from their initial values 504 and stepping these values forward in time by picking random increments that are consistent with the market model being used. All points in time necessary to evaluate the simulated investment performance to the desired horizon are included in the steps. Each set of steps from the beginning to the end of the investment constitutes one path, and many paths are generated. The performance of the investment over each path is calculated and statistical properties of the investment are accumulated over all the paths.

For the method 500 discussed here, the usual Monte Carlo procedure must be modified since we need to specify both the initial and final values of the benchmarks; the Monte Carlo procedure 500 then fills in the intermediate values on each path with random or quasi-random values, using Brownian Bridges techniques, consistent with the market model plus beginning and ending benchmark values 506. The investment performance is evaluated over each path as in the usual case and statistical properties of the investment are accumulated over all paths as usual 508. This process is repeated until a specified/predetermined number of paths have been generated or a measure of accuracy has been reached, or a stopping criteria has been reached 510, or in some alternative embodiments, a time-span elapses or any other event which would trigger the end of the above process.

Standard statistical textbooks discuss a random process called the Brownian Bridge which provides a straightforward technique for modifying Monte Carlo simulations based on Brownian Motion (which is the case for Black-Scholes market models as well as many others). Textbooks and articles discussing Monte Carlo simulation with Brownian Bridges are well known in the art. Generally speaking, the usual procedure of stepping forward in time is replaced by a procedure where two points in time where the benchmark values are already known (the initial and final points at the start of the simulation) are used to fill in the values at another point in time between them. There are many ways to choose the exact sequence of filling, e.g. filling unknown values forwards in time, backwards in time, or recursively bisecting the time line (i.e. filling in the point closest to the middle of an interval defined by two known points and then doing the same to the two new intervals this creates). For the example discussed here, there is no reason to prefer a particular order of filling. Statistical textbooks give the necessary formulas for generating the random values at the intermediate (sometimes referred to as interpolated) point that are consistent with the market model and known bracketing values. Note that textbook discussions of Monte Carlo simulation with Brownian Bridges typically do not assume the same end point is used for each path but rather generate an appropriate end point for each path; other than this the textbook discussions apply here.

The expected value of the investment performance over all the Monte Carlo paths provides a good estimate of the expected performance of the investment depending only on the initial and final benchmark values, benchmark volatility, benchmark yield, and interest rate (quite similar to an option pricing formula). The Monte Carlo procedure 500 calculates the desired statistical properties and other correlating data, e.g., investment return, investment performance, and other easily understood market characteristics which would be recognized by one of ordinary skill in the art, and can be used to prepare summary information (such as tables and graphs) for investors or could be delivered to investors in interactive form via a web browser or computer application if adequate computing capacity is available 512.

Other statistical information about investment performance can also be captured during the Monte Carlo procedure, such as the standard deviation, confidence levels, or even a full distribution of outcomes. The Monte Carlo procedure 500 automatically captures the uncertainty in volatility due to discrete sampling as discussed for the Continuous-Time method, so no separate estimate of this is necessary 512.

For most uses the previous methods are preferred as they are much more efficient and easier to deliver to investors. However, the simulation provides a simple way to produce a complete distribution of results, as opposed to basic statistical measures. The Monte Carlo procedure 500 ends with step 514 in correlation to step 408 of FIG. 4.

Alternate embodiments of the Monte Carlo Brownian Bridge procedure 400, 500 may include incorporating transaction costs. The Monte Carlo procedure 400, 500 can be used to evaluate an investment's performance with ½ day, 1 day, 2 day, etc. periods and utilize these results to select a period that was optimum in regard to some criterion (e.g. balance uncertainty in outcome against cost).

In cases where the Continuous-Time method 200 and Taylor Series Expansion of Compounding method 300 do not apply, the Monte Carlo simulation 500 can always be used and hence its importance. It may also be easier to incorporate market models other than Black-Scholes in the Monte Carlo method. This method may also be used to study how the length of the actual investment periods affects the investment performance and optimize the length.

The Continuous-Time method 200 and Taylor Series Expansion of Compounding method 300 can easily be delivered to investors in interactive form through web browsers or stand-alone computer applications as well as in summary form. The Monte Carlo method 500 requires much more computation and is less suitable for use in interactive form. In some circumstances, for example if the investor is a professional investor or institution with substantial computing capacity or if the Monte Carlo path generation can distributed over a large number of computers, even the third method can be delivered in interactive form. When delivered through a web browser, the computations involved in any of the methods might be carried out at the web server (“server-side”) or on the computer displaying the web page (“client-side”). Interactive delivery is desirable as it allows the investor to study any scenario that interests him as opposed to ones that were pre-selected.

Alternative embodiments of the present invention corresponding to the Continuous-Time method 200, the Taylor Series Expansion of Compounding method 300, the Monte Carlo simulation 500, and any subsequent combination thereof, may focus on situations where the investor not only specifies an initial benchmark value (typically the current market value) and a final value at some time in the future, but may also require the investor to specify the value at any arbitrary allocation of time (i.e., today, tomorrow, half-way, and/or the final value).

Although particular embodiments have been disclosed herein in detail, this has been done by way of example for purposes of illustration only, and is not intended to be limiting with respect to the scope of the appended claims, which follow. In particular, it is contemplated that various substitutions, alterations, and modifications may be made without departing from the spirit and scope of the invention as defined by the claims. Other aspects, advantages, and modifications are considered to be within the scope of the following claims. The claims presented are representative of the inventions disclosed herein. Other, unclaimed inventions are also contemplated. The applicant reserves the right to pursue such inventions in later claims.

What is claimed is:

1. A method for evaluating investment performance of an investment, comprising:
setting a period of evaluation of the investment;
determining initial benchmark and final benchmark values for the investment for the period;
determining market characteristics within the period;
applying a substantially constant leveraging factor L to the investment;
converting investment rules, benchmark value, investment value and the market characteristics to continuous functions of time in accordance with the formula d(ln V)=L*d(ln S),
wherein V is the investment value and S denotes a benchmark value; and
estimating an expected performance V(T) of the investment for T years for the market characteristics in accordance with a formula:
V(T)=(S_{T}/S_{O})^{L}e^{yT},y=Lq+(1−L)r+L(1−L)σ²/2,
wherein S_{O} is the current value of the benchmark, S_{T} is the value of the benchmark after T years, q is the average benchmark dividend yield, r is the average funding rate for the investment, and σ² is the average benchmark variance over the period.

2. The method of claim 1, wherein estimating the expected performance comprises estimating discrete sampling effects of the market characteristics, and wherein the discrete sampling effects are propagated through a continuous-time solution.

3. The method of claim 2, wherein the market characteristics comprise at least one of volatility, correlations, yields, divides, yields and interest rates.

4. The method of claim 1, wherein solving of the formula for estimating the expected performance includes a closed form solution, comprising:
calculating an average benchmark dividend yield over the period;
evaluating an average benchmark variance over the period;
determining an average funding rate for the investment over the period; and
equating the average benchmark dividend yield, the average benchmark variance, the average funding rate, the initial benchmark value, the final benchmark value to determine the performance of the investment to determine the expected performance.

5. The method of claim 1, wherein solving the formula for estimating the expected performance comprises a numerical solution.

6. The method of claim 1, wherein the formula d(ln V)=L*d(ln S) correlates with a function of form V=S^{L}.

7. A method for evaluating performance of an investment, comprising:
setting a multi-period of evaluation for the investment;
determining one or more market characteristics;
determining initial benchmark and final benchmark values for each individual period, wherein each individual period is a predetermined interval;
determining a return of the investment over the multi-period;
compounding the multi-period returns to realize a total return in accordance with the formula:
ln(1+rₜₒₜₐₗ)=ln(1+rᵢ)+ln(1+r₂) . . . +ln(1+r_{N}),
wherein rᵢ=L*(Sᵢ/Sᵢ₋₁);
approximating the multi-period returns via at least second order expansion;
expressing first order benchmark returns for each the individual period in accordance with the formula ln(Sᵢ₊₁/Sᵢ), where Sᵢ are benchmark values;
summing the benchmark returns for the multi-period to produce a first-order total return in accordance with the formula ln(S_{N}/S_{O}), wherein S_{O} is a initial benchmark value and S_{N} is a final benchmark value for the multi-period of evaluation;
calculating expected values over intermediate benchmark values to eliminate the intermediate benchmark values from terms of an order greater than 1; and
summing all of the multi-period returns and a funding return via the formula:
V(T)=(S_{T}/S_{O})^{L}e^{yT},y=Lq+(1−L)r+L(1−L)(σ²/2+σ⁴t/4),
wherein T is the total investment period, t is the basic compounding period in years, L represents a substantially constant leverage value, σ⁴ captures effects of discrete compounding and σ² yields statistical properties of the total return, and
wherein an effective funding rate is (Lq+(1−L)*r), where q is the dividend rate, and r is the interest rate.

8. The method of claim 7, wherein the at least second order expansion of the multi-period returns are utilized to increase accuracy of the total return.

9. The method of claim 7, wherein higher-order terms become functions of statistical properties of the multi-period benchmark values.

10. The method of claim 7, wherein the summing of the benchmark returns occurs during independent increments of the periods.

11. The method of claim 7, wherein the summing of the benchmark returns occurs during independent increments of the periods which are conditioned on the final benchmark value.

12. The method of claim 7, wherein the expected values are calculated to a second-order accuracy, and wherein the calculation comprises using a log-normal assumption of the intermediate values.

13. The method of claim 7, further comprises estimating discrete sampling effects of the market characteristics, and wherein the discrete sampling effects are propagated through the summing formula.

14. The method of claim 13, wherein the market characteristics comprise at least one of volatility, correlations, yields, divides, yields and interest rates

15. A method for estimating multi-period performance of an investment comprising:
selecting a market model to be utilized for simulation;
initiating two benchmark values at a starting value and a final value;
filling the benchmark values during intervals present within the multi-period, wherein random or quasi-random increments are utilized that are consistent with the market model plus starting and final values;
generating a path of random values consistent with the market model plus the starting and the final values by utilizing a statistical technique, wherein the statistical technique is applied to utilize the starting benchmark value and the final benchmark value;
evaluating investment performance parameters over the path; and
accumulating statistical properties of the investment.

16. The method of claim 15, further comprising:
detailing the evaluation of investment performance and the statistical performance for review by the investor

17. The method of claim 15, wherein the method is repeated until a predetermined number of paths have been generated.

18. The method of claim 15, wherein the method is repeated until a predetermined measure of accuracy has been attained.

19. The method of claim 15, wherein the filling of benchmark values occurs either forwards in time or backwards in time, or recursively via bisecting the time line of the multi-period and filling in values based on proximity towards the bisection.

20. The method of claim 15, wherein the investment performance parameters comprise at least one of the initial benchmark value, final benchmark value, benchmark volatility, benchmark yield and interest rate.

21. The method of claim 15, wherein the statistical technique applied is a Brownian Bridges technique.
